(19) United States
(12) Patent Application Publication
(10) Pub. No.: US 2026/0367833 A1
(43) Pub. Date: Nov. 19, 2026

(54) PERFORMING LOW-LATENCY WRITE OPERATIONS IN A STORAGE SERVICE

(71) Applicant: Microsoft Technology Licensing, LLC, Redmond, WA (US)

(72) Inventors: Jason RAHMAN, Carnation, WA (US); Girish MITTUR VENKATARAMANAPPA, Redmond, WA (US); Quetzalcoatl BRADLEY, Kennewick, WA (US); Rameez SAJWANI, Kirkland, WA (US); Wei CHEN, Sammamish, WA (US)

(21) Appl. No.: 19/249,110

(22) Filed: Jun. 25, 2025

Related U.S. Application Data
(60) Provisional application No. 63/807,767, filed on May 18, 2025.

(51) Int. Cl. G06F 3/06

(52) U.S. Cl. CPC G06F 3/0659; G06F 3/0611; G06F 3/0683

(57) ABSTRACT

Methods, apparatuses, and products for performing low-latency write operations in a computing system, including: partitioning a set of processing units of the computing system into a first subset and a second subset; assigning, to each processing unit in the first subset, one or more dedicated threads configured to execute latency sensitive write path operations; assigning, to each processing unit in the second subset, one or more threads for performing latency insensitive operations; and processing write operations using the first subset of processing units, including: executing a non-blocking polling loop on the processing units in the first subset to detect input/output (‘I/O’) activity related to write path operations; and persisting write data to a storage device in the computing system.

### BACKGROUND

In computing systems that perform a combination of latency-sensitive and latency-insensitive operations, interference between these classes of operations can cause elevated and unpredictable tail latency for the latency-sensitive operations. Latency-sensitive operations may be delayed when they share processing units with latency-insensitive operations, even when overall system utilization appears stable. General-purpose schedulers typically optimize for throughput or fairness, not latency determinism. As a result, latency-sensitive operations may suffer performance degradation under mixed workloads.

Existing approaches may reduce contention, but often lack consistent enforcement in environments where blocking behavior or system-driven scheduling is present. Latency-insensitive operations, including background tasks and maintenance routines, can introduce variability that impacts the responsiveness of performance-critical workloads. In systems that handle write operations requiring low and predictable latency, such variability can be especially problematic. There remains a need for techniques that preserve latency stability by managing how different classes of operations are scheduled and executed.

### SUMMARY

According to embodiments of the present disclosure, various methods, apparatus, and products for performing low-latency write operations in a computing system are described herein. In some aspects, performing low-latency write operations in a computing system includes: partitioning a set of processing units of the computing system into a first subset and a second subset; assigning, to each processing unit in the first subset, one or more dedicated threads configured to execute latency sensitive write path operations; assigning, to each processing unit in the second subset, one or more threads for performing latency insensitive operations; and processing write operations using the first subset of processing units, including: executing a non-blocking polling loop on the processing units in the first subset to detect input/output (‘I/O’) activity related to write path operations; and persisting write data to a storage device in the computing system. In some aspects, an apparatus may include a memory and one or more processing devices, operatively coupled to the memory, the one or more processing devices configured to perform similar steps. In some aspects, a computer program product comprising a computer readable storage medium may store computer program instructions that, when executed, perform similar steps.

### BRIEF DESCRIPTION OF DRAWINGS

FIG. 1 sets forth a block diagram of an edge platform used to perform low-latency write operations in accordance with some embodiments of the present disclosure.

FIG. 2 sets forth a flow chart illustrating an example method of performing low-latency write operations in a computing system in accordance with some embodiments.

FIG. 3 sets forth a flow chart illustrating an additional example method of performing low-latency write operations in a computing system in accordance with some embodiments.

FIG. 4 sets forth a flow chart illustrating an additional example method of performing low-latency write operations in a computing system in accordance with some embodiments.

FIG. 5 sets forth a flow chart illustrating an additional example method of performing low-latency write operations in a computing system in accordance with some embodiments.

FIG. 6 sets forth an example of a computing device that may be used in accordance with some embodiments.

FIG. 7 sets forth a block diagram of a cloud service provider service architecture in accordance with some embodiments of the present disclosure.

### DESCRIPTION OF EMBODIMENTS

Many computing systems today are responsible for processing large volumes of data with minimal delay, particularly in contexts where write operations must be completed quickly and reliably. This is increasingly important in domains such as real-time analytics, financial transactions, and many other domains where the speed of write operations directly impacts service quality. In these settings, even brief latency spikes can lead to missed deadlines, throughput degradation, or unpredictable system behavior.

Traditional computing architectures often fall short when it comes to guaranteeing low and consistent latency for write operations. Techniques such as thread prioritization or generic load balancing can help in some cases, but they typically do not provide the level of isolation or responsiveness needed by demanding applications. This is especially true in multi-core systems, where contention between threads can introduce variability that is difficult to control.

The techniques described in this disclosure offer a structured way to address this problem by partitioning the available compute resources within a system into distinct functional roles. Instead of relying on a uniform pool of processors that serve all tasks equally, the system organizes its processing units into two groups. One group is dedicated to executing latency-sensitive write operations, while the other is responsible for handling operations that are more tolerant of delay. This partitioning provides a degree of operational clarity that helps reduce contention and improves the predictability of performance.

Within the latency-sensitive group, each processing unit is assigned one or more threads that perform critical tasks such as polling for input/output activity and committing write data to storage. These threads are configured to operate without blocking and can be bound directly to specific cores or logical processors using thread affinity settings. This ensures that they execute in a consistent environment and are not subject to interruptions or migration by the operating system scheduler. As a result, the system can maintain stable and low-latency behavior even under varying load conditions.

The second group of processing units handles the rest of the system's workload. This includes metadata updates, background synchronization tasks, and transmission of previously persisted data to remote systems. These tasks are important for system consistency and durability but do not typically require the same level of responsiveness. By isolating them from the write path, the system can schedule them more flexibly and without compromising the performance of latency-sensitive threads.

By isolating latency-sensitive operations from other system activity and executing them on dedicated processing units with pinned threads, the described techniques improve the determinism and responsiveness of the computing system. This leads to measurable improvements in system behavior, including reduced write latency, lower variance in response times, and more efficient utilization of processor cache and memory locality. The elimination of blocking and thread migration reduces overhead caused by context switching and scheduler intervention, which contributes to more consistent performance under load. These benefits enhance the system's ability to meet real-time or near-real-time processing requirements using standard hardware configurations. Moreover, the ability to maintain high performance without requiring specialized hardware or intrusive kernel modifications supports broader deployability across a range of environments.

Adopting this solution can lead to improved service reliability and responsiveness, which in turn enhances the end-user experience in latency-sensitive applications such as real-time analytics platforms, financial systems, and database applications (particularly Online Transaction Processing (‘OLTP’) database applications), and others. By ensuring that write operations complete consistently and without delay, organizations can meet tighter service-level objectives and reduce the risk of data loss or operational downtime. This increased performance predictability can support the deployment of premium, latency-sensitive offerings, opening opportunities in new market segments where responsiveness is a key differentiator. Additionally, improved system efficiency can lower infrastructure costs or defer scaling expenses, contributing to more favorable margins as demand grows.

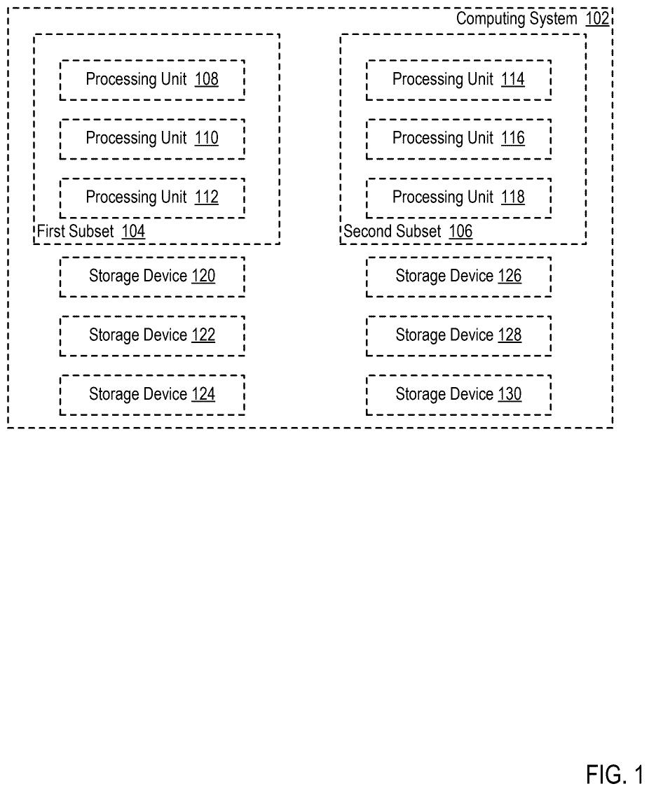

For further explanation, FIG. 1 sets forth a block diagram of a computing system 102 in accordance with some embodiments of the present disclosure. The computing system 102 can be configured to perform low-latency write operations, in accordance with various embodiments described herein. As shown, the computing system 102 includes a set of processing units and storage devices, partitioned to separately handle latency-sensitive and latency-insensitive operations in a performance-optimized manner.

The computing system 102 may comprise a physical or virtualized compute platform capable of executing threads and accessing persistent storage. In the illustrated embodiment, a set of processing units is partitioned into a first subset 104 and a second subset 106. Each processing unit may correspond to a central processing unit (CPU), a CPU core, or another discrete compute element that can execute assigned threads. These processing units may be implemented using any suitable processor architecture, including x86-based processors, ARM cores, or equivalent general-purpose compute engines.

The first subset 104 includes processing units 108, 110, and 112, each of which is assigned one or more dedicated threads configured to execute latency-sensitive write path operations. These operations may include polling for input/output (I/O) activity, receiving write data from upstream systems, and persisting that data to storage devices with minimal delay. To achieve low-latency performance, threads associated with the first subset may be pinned to specific processing units using thread affinity mechanisms provided by the operating system or a runtime environment, helping to ensure deterministic execution behavior.

The second subset 106 includes processing units 114, 116, and 118, each assigned threads for latency-insensitive tasks, such as background metadata processing, replication of already persisted data to remote storage, or other ancillary operations. These threads may be scheduled with less stringent real-time constraints, allowing the system to isolate critical write paths from performance fluctuations caused by non-critical workloads.

The computing system 102 also includes several storage devices, which may be distributed across both subsets. In the illustrated configuration, storage devices 120, 122, and 124 are accessible to the first subset 104, while storage devices 126, 128, and 130 are associated with the second subset 106. These storage devices may include any form of non-volatile memory suitable for high-performance data persistence, such as solid-state drives (SSDs), NVMe storage, or other high-throughput block storage devices. The first subset may be preferentially used to persist write data as part of the main write path, while the second subset may be used to support post-persistence operations.

Although not explicitly depicted in FIG. 1, in some embodiments the computing system 102 can also include additional components to support its operations. For example, the system may include volatile main memory (such as DRAM) used to temporarily buffer write requests or manage internal data structures accessed by processing threads. The system may also incorporate one or more network interface controllers (NICs) to receive write data from external sources over high-speed links, such as Ethernet or RDMA-capable fabrics. In certain configurations, the system may use scheduler logic to enforce policies for assigning threads to processing units and selecting the composition of the first and second subsets based on real-time load, quality-of-service requirements, or performance isolation goals.

While the configuration shown in FIG. 1 is one illustrative embodiment, the architecture of computing system 102 is not limited to the specific number or arrangement of components depicted. Other embodiments may include different numbers of processing units or storage devices, or may implement the described functionality across multiple systems in a distributed architecture. Such variations remain within the scope of the inventive concepts disclosed herein, which are directed primarily toward the efficient handling of low-latency write operations via processing unit partitioning and thread specialization.

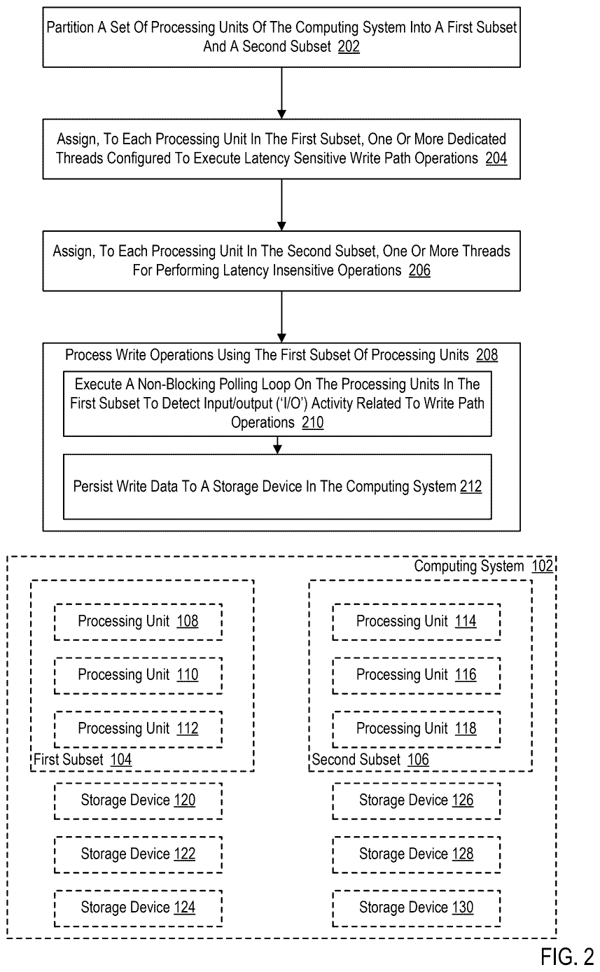

For further explanation, FIG. 2 sets forth a flow chart illustrating an example method of performing low-latency write operations in a computing system 102 in accordance with some embodiments. The computing system 102 depicted in FIG. 2 is similar to the computing system depicted in FIG. 1 and described above. In some embodiments, the computing system 102 comprises a server-class machine, a virtualized environment, or a system-on-chip that includes a plurality of processing units and direct access to one or more local storage devices. The method of FIG. 2 can be carried out, for example, by one or more software modules executing on the computing system 102.

The example method depicted in FIG. 2 includes partitioning 202 a set of processing units 108, 110, 112, 114, 116, 118 of the computing system 102 into a first subset 104 and a second subset 106. Partitioning 202 a set of processing units can be carried out, for example, by configuring the operating system of the computing system 102 to reserve specific physical cores for exclusive use by latency-sensitive threads. This can include applying Linux kernel boot-time configuration parameters such as isolcpus to prevent the system scheduler from placing unrelated tasks on the designated cores. In some embodiments, partitioning is enforced at runtime through kernel interfaces such as cpuset or by setting thread affinity masks using system calls or interfaces like sched_setaffinity. These mechanisms ensure that processing units in the first subset 104 are shielded from background tasks and used exclusively for polling-based write operations. In some embodiments, the partitioning is static and defined at system boot, while in others it may be reconfigured under administrative control. In some embodiments, partitioning 202 does not require virtualization or container-level orchestration and can be implemented directly at the host operating system level.

In the example depicted in FIG. 2, processing units 108, 110, 112 are partitioned 202 into the first subset 104 and processing units 114, 116, 118 are partitioned into the second subset 106. Partitioning 202 the processing units into these subsets can be carried out, for example, by specifying processor identifiers in a boot-time argument such as isolcpus, which instructs the kernel to exclude the first subset 104 from the general-purpose scheduler. Alternatively, a user space initialization script or provisioning tool may assign threads to processing units through calls to sched_setaffinity, or by placing threads into cpusets that are configured to map exclusively to the designated processing units. In these embodiments, the goal of the partitioning is to ensure that no unrelated system or user-level work is scheduled on processing units 108, 110, 112, such that dedicated polling threads can execute uninterrupted and with minimal latency variation. Processing units in the second subset 106 can remain under control of the operating system scheduler and may execute general-purpose or latency-insensitive workloads as needed.

The example method depicted in FIG. 2 also includes assigning 204, to each processing unit 108, 110, 112 in the first subset 104, one or more dedicated threads configured to execute latency sensitive write path operations. Assigning 204 a dedicated thread to each processing unit 108, 110, 112 in the first subset 104 can be carried out, for example, by launching a user-space thread or process that is bound to the corresponding processing unit through processor affinity settings or operating system scheduling interfaces such as sched_setaffinity. In some embodiments, one dedicated thread is assigned per processing unit in the first subset 104 to maximize Central Processing Unit (‘CPU’) cache locality, avoid thread contention, and reduce interrupt-based jitter. Each thread can be configured to execute a write path loop that carries out tasks such as receiving write data, persisting the data to local storage, and signaling write completion. In some embodiments, the thread operates in user space and uses polling-based Input/Output (‘I/O’) techniques such as busy waiting on file descriptors or kernel-bypass Application Programming Interfaces (‘APIs’) like io_uring and Storage Performance Development Kit (‘SPDK’). In other embodiments, the thread may access a direct memory region used for hardware-assisted data ingestion, such as a Direct Memory Access (‘DMA’) capable network interface. For example, a thread assigned to processing unit 108 may continuously check a memory ring buffer mapped from an Remote Direct Memory Access (‘RDMA’) queue pair to detect new write data submitted remotely by a client. In another example, the thread may use an Field Programmable Gate Array (‘FPGA’) based hardware accelerator to receive pre-processed Write-Ahead Log (‘WAL’) records and commit them to local storage.

The example method depicted in FIG. 2 also includes assigning 206, to each processing unit 114, 116, 118 in the second subset 106, one or more threads for performing latency insensitive operations. Assigning 206 threads to each processing unit 114, 116, 118 in the second subset 106 can be carried out, for example, by launching a set of general-purpose worker threads that are managed by the system scheduler and allowed to share CPU time. In some embodiments, these threads handle slow path operations such as reading historical write-ahead logs, replicating stored data to remote locations, maintaining metadata indexes, or executing background consistency checks. In some embodiments, the slow path threads communicate with other system components through message queues, Inter-Process Communication (‘IPC’) channels, or shared memory regions. For example, a slow path thread assigned to processing unit 116 may dequeue archived WAL entries and stream them to a remote backup service. In other embodiments, the slow path thread may operate as a consumer of completion messages generated by the write path threads to trigger asynchronous post-processing. These operations can be multiplexed across the processing units in the second subset 106 without guaranteeing CPU isolation, as jitter sensitivity is not a concern.

The example method depicted in FIG. 2 also includes processing 208 write operations using the first subset 104 of processing units 108, 110, 112. Processing 208 write operations can be carried out, for example, by executing a specialized runtime on each dedicated thread, wherein each runtime is responsible for detecting incoming write data, preparing the data for persistence, and coordinating with storage backends. In some embodiments, each thread operates independently and does not use shared locking or synchronization mechanisms with other threads in the system. In some embodiments, the runtime executing on each processing unit can be a custom event loop written in a memory-safe language such as Rust, designed to wrap io_uring or another asynchronous IO mechanism. In other embodiments, the runtime may use Data Plane Development Kit (‘DPDK’) to access network packets directly from a network interface queue and forward them to a local storage writer. As an example, a thread executing on processing unit 110 may directly poll an RDMA completion queue for a new write buffer submitted by a remote client, initiate a write to local Non-Volatile Dual In-line Memory Module (‘NVDIMM’) storage, and then transmit an RDMA write with immediate acknowledgment in response. In still other embodiments, the thread may participate in a distributed commit protocol by generating a log sequence number and submitting replication metadata to a coordination service. Processing 208 write operations in this way ensures that critical IO paths operate with low latency and minimal interference from unrelated system activity.

In the example method depicted in FIG. 2, processing 208 write operations using the first subset 104 of processing units 108, 110, 112 includes executing 210 a non-blocking polling loop on the processing units 108, 110, 112 in the first subset 104 to detect I/O activity related to write path operations. Executing 210 a non-blocking polling loop on the processing units 108, 110, 112 in the first subset 104 may be carried out, for example, by having each dedicated thread spin on a descriptor or device queue until data becomes available. In some embodiments, the polling loop monitors an io_uring completion queue to detect when new data has arrived over a socket or when a prior write operation has completed. In other embodiments, the polling loop may access a DPDK receive ring for incoming packets or a memory-mapped FPGA queue for structured write requests. In some embodiments, the polling loop includes logic to batch incoming operations for improved throughput while maintaining strict upper bounds on latency. For example, a polling loop running on processing unit 112 may check a series of write queues every CPU cycle and invoke a user-space flush routine once a threshold number of writes have been buffered. Because the threads are dedicated and never block, they can detect and act on I/O events in near-constant time.

In the example method depicted in FIG. 2, processing 208 write operations using the first subset 104 of processing units 108, 110, 112 also includes persisting 212 write data to a storage device 120, 122, 124, 126, 128, 130 in the computing system 102. Persisting 212 write data can be carried out, for example, by submitting write operations to a local Non-Volatile Memory Express (‘NVMe’) device using either direct system calls or a user-space storage stack. In some embodiments, write data is persisted through io_uring submission queues and completion events, while in others, the data is submitted to a user-space storage library such as SPDK that provides kernel-bypass NVMe access. In some embodiments, the storage device is a persistent memory device (e.g., Intel Optane DC PMem) that is accessed through a byte-addressable load/store interface. For example, a dedicated thread running on processing unit 108 may directly copy a received buffer into a memory mapped region backed by a Direct Access (‘DAX’) filesystem, followed by a memory fence and durability guarantee using pmem_persist. In other embodiments, the thread may use RDMA write-with-imm operations to trigger a mirrored write to a remote replica's NVDIMM space, followed by a local write to storage device 124. In still other embodiments, the persistence operation includes updating a WAL index stored in a shadow memory region or sending metadata messages to the metadata thread to update global consistency state.

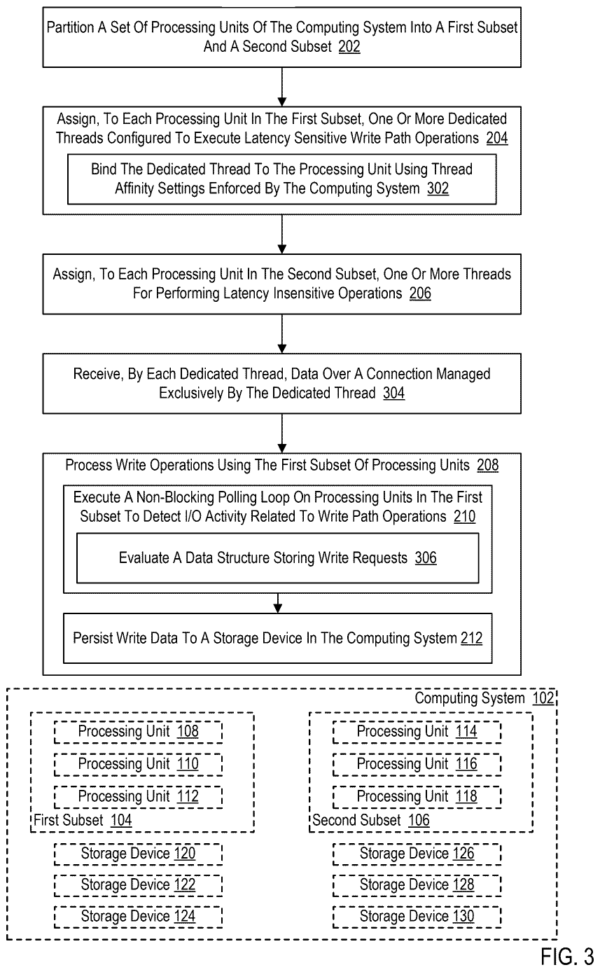

For further explanation, FIG. 3 sets forth a flow chart illustrating an additional example method of performing low-latency write operations in a computing system 102 in accordance with some embodiments. In the example depicted in FIG. 3, assigning 204 one or more dedicated threads configured to execute latency sensitive write path operations to each processing unit 108, 110, 112 in the first subset 104 includes binding 302 the dedicated thread to the processing unit 108, 110, 112 using thread affinity settings enforced by the computing system 102. Binding 302 the dedicated thread to the processing unit 108, 110, 112 (i.e., to one processing unit 108, 110, 112 in the first subset 104) can be carried out, for example, by configuring the computing system 102 to enforce exclusive assignment of the thread to the designated processing unit. In some embodiments, the binding is performed by a thread supervisor, runtime environment, or system initialization process that sets processor affinity attributes before the thread begins execution. In other embodiments, binding is enforced by issuing system calls such as sched_setaffinity or writing to kernel interfaces such as cpuset configuration files. In some embodiments, affinity settings can be defined by configuration values that are passed to the thread as part of its launch parameters, while in other embodiments, the binding can be applied programmatically by a control loop that monitors thread placement and reasserts affinity if changes are detected. Binding the thread to the processing unit ensures that no unrelated tasks are scheduled on the same resource and allows the thread to operate with minimal scheduling interference and stable cache residency.

The example method depicted in FIG. 3 also includes receiving 304, by each dedicated thread, data over a connection managed exclusively by the dedicated thread. Receiving 304 data over a dedicated connection can be carried out, for example, by establishing a data channel that is managed exclusively by the dedicated thread, and directing incoming write data into a memory region monitored by the thread. In some embodiments, the data channel is a socket-based network connection, such as a TCP or UDP socket, that is assigned to the thread during connection setup and read directly from within the thread's polling loop. In other embodiments, the data channel is a low-latency communication path such as a queue pair in an RDMA transport. In some embodiments, the connection is established by a listener or session manager component that delegates accepted connections to threads using a deterministic assignment strategy, such as a round-robin allocator or a thread-to-connection affinity table. Once the connection is assigned, the thread reads data directly without requiring handoff to or from other threads. This arrangement ensures that each thread controls its own ingress path, maintains data locality, and avoids delays caused by coordination or locking. For example, a thread executing on processing unit 110 may read from a memory-mapped NIC ring buffer or poll a socket descriptor, receive a stream of write data from a remote system, and initiate persistence operations without passing data to other components in the computing system 102.

In the example depicted in FIG. 3, executing 210 a non-blocking polling loop on the processing units 108, 110, 112 in the first subset 104 to detect I/O activity related to write path operations includes evaluating 306, by each dedicated thread, a data structure storing write requests. Evaluating 306 a data structure storing write requests can be carried out, for example, by repeatedly accessing a memory region, queue, or buffer that is updated when new data becomes available. In some embodiments, the data structure can be implemented as a ring buffer, completion queue, or shared descriptor array. In some embodiments, the polling loop can accesses a submission queue from an asynchronous I/O mechanism such as io_uring, or a receive queue provided by a user-space networking stack such as DPDK. In other embodiments, the polling loop can interact with a device-specific region of memory, such as a queue entry in an RDMA or NVMe interface, to detect readiness. In some embodiments, polling behavior can include speculative batching or peek-based checks to identify multiple requests before issuing writes. The polling loop may repeatedly evaluate the data structure to determine whether a new write request is available and, if so, initiates persistence operations without entering a blocking state.

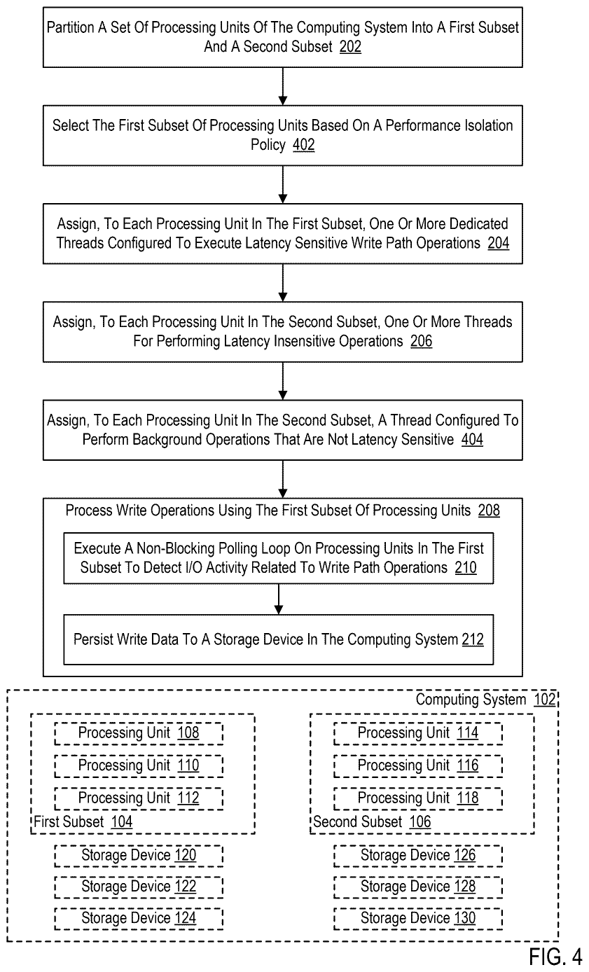

For further explanation, FIG. 4 sets forth a flow chart illustrating an additional example method of performing low-latency write operations in a computing system 102 in accordance with some embodiments. The example depicted in FIG. 4 also includes selecting 402, by the computing system 102, the first subset 104 of processing units 108, 110, 112 based on a performance isolation policy. Selecting 402 the first subset 104 based on a performance isolation policy can be carried out, for example, by identifying processing units that are not currently assigned to general-purpose workloads, by referencing a configuration file or deployment manifest that specifies reserved cores for latency-sensitive execution, or in some other way. In some embodiments, the policy may be defined statically during system initialization, while in other embodiments it may be determined dynamically by a resource manager or administrator. The policy may consider criteria such as, for example, existing core assignments, expected contention, or isolation guarantees. In some embodiments, the computing system 102 selects the first subset 104 of processing units 108, 110, 112 in a way that avoids assigning unrelated work to cores that serve latency-sensitive threads. For example, the computing system 102 may reference configuration inputs or runtime indicators to ensure that dedicated threads are not collocated with background processes on the same cache domain.

The example depicted in FIG. 4 also includes assigning 404, to one or more processing units 114, 116, 118 in the second subset 106, one or more threads configured to perform background operations that are not latency sensitive. Assigning 404 threads for background operations to one or more processing units 114, 116, 118 in the second subset 106 can be carried out, for example, by launching system or application threads that are scheduled using the default operating system policy or a relaxed quality-of-service level. In some embodiments, background operations may include periodic data scans, replication tasks, archival writes, index maintenance, log cleanup, telemetry collection, consistency checks, and so on. These operations may be triggered, for example, by a task scheduler, a maintenance loop, or an event-driven handler. In some embodiments, threads assigned to the second subset 106 of processing units 114, 116, 118 may be preemptible, migratable, or scheduled concurrently with other work. For example, a thread executing on processing unit 116 may be configured to read and compress previously persisted data, while a thread on 118 may coordinate data movement to other systems, such as replication or archival services, in a manner that tolerates variable latency.

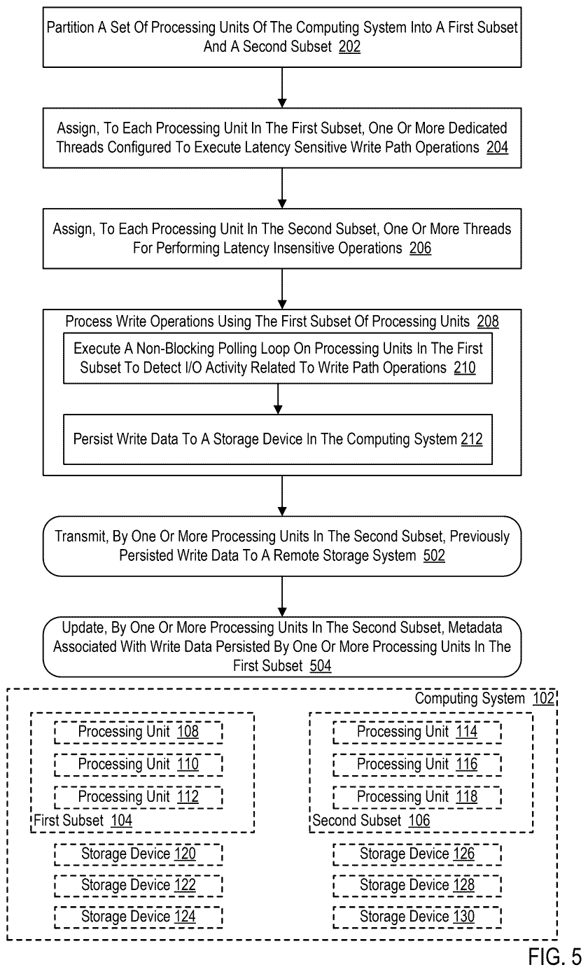

For further explanation, FIG. 5 sets forth a flow chart illustrating an additional example method of performing low-latency write operations in a computing system 102 in accordance with some embodiments. The example method depicted in FIG. 5 includes optionally transmitting 502, by one or more processing units 114, 116, 118 in the second subset 106, previously persisted write data to a remote storage system. Transmitting 502 previously persisted write data can be carried out, for example, by one or more processing units 114, 116, 118 in the second subset 106 reading durable log entries or write-ahead records from local storage and forwarding the data to a remote archival tier, replica system, object store, or some other remote storage resource. In some embodiments, the data may be transmitted over a network socket, a shared memory interface, or a high-throughput transport channel such as RDMA or HTTP-based streaming. In other embodiments, the second subset 106 is configured to batch outgoing data or schedule transmissions during periods of reduced contention. In some embodiments, the computing system 102 prioritizes the write path while allowing background transmission to proceed opportunistically. For example, a thread executing on processing unit 118 may periodically scan a write-ahead log for unarchived segments, read those segments from an NVMe device, and issue a network write to a backup service or cold storage system.

The example method depicted in FIG. 5 includes optionally updating 504, by one or more processing units 114, 116, 118 in the second subset 106, metadata associated with write data persisted by one or more processing units 108, 110, 112, in the first subset 104. Updating 504 metadata can be carried out, for example, by the one or more processing units 114, 116, 118 in the second subset 106 maintaining a structure that reflects logical offsets, replication status, check-sums, or retention state for persisted write entries. In some embodiments, the metadata is derived from messages or tokens passed from the first subset 104 as part of a handoff protocol or messaging queue. In other embodiments, a thread in the second subset 106 monitors a shared region of memory or receives asynchronous notifications when new data becomes durable. The metadata may be used to track durability guarantees, construct consistency checkpoints, or support indexing and lookup operations. For example, a thread executing on processing unit 114 may receive an identifier for a committed write, associate it with a physical storage location, and update a metadata map that is used for subsequent access, audit, or lifecycle management.

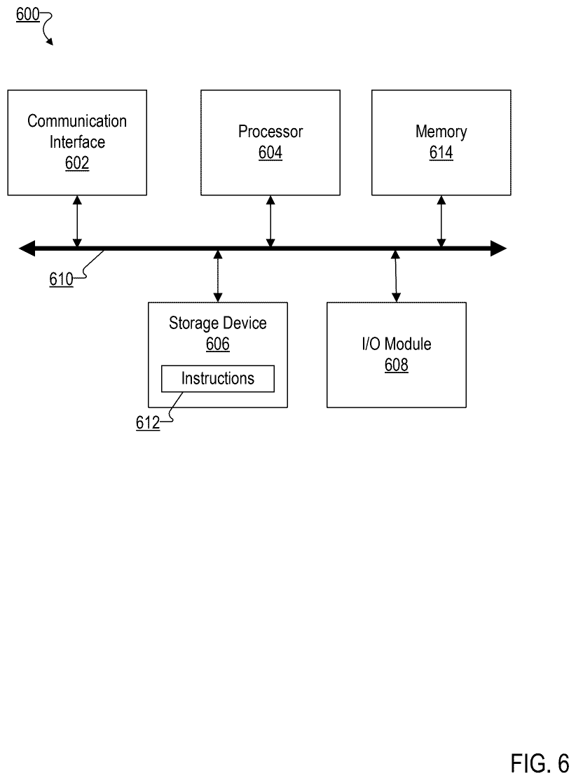

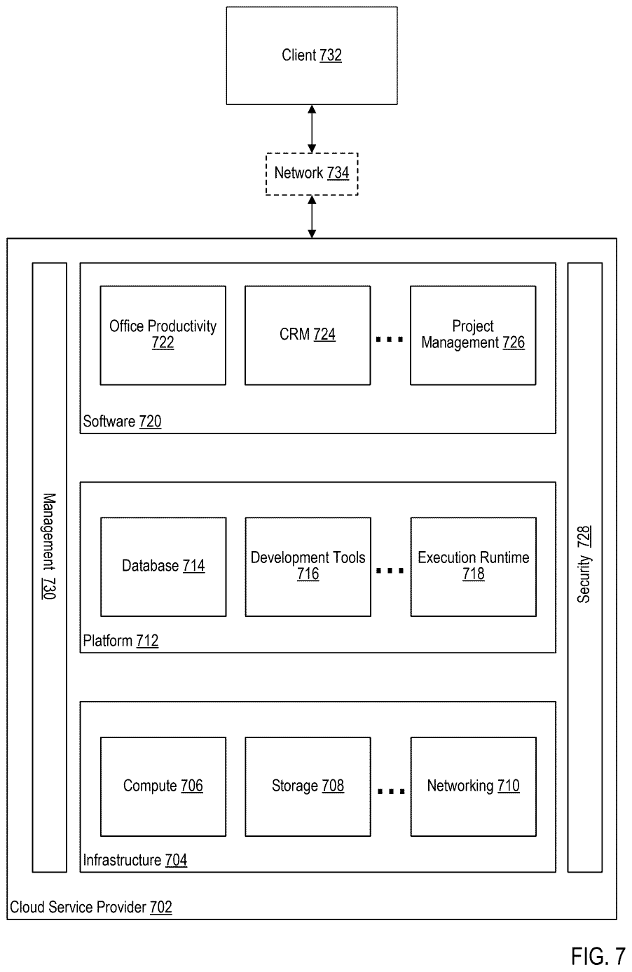

For further explanation, the sections included below provide some details regarding technologies that may be used in accordance with some embodiments. For example, FIG. 6 sets forth an example of a computing device that may be used for some portion of securing an operating system in accordance with some embodiments. As an additional example of technologies that may be used, FIG. 7 sets forth a block diagram of a cloud service provider 702 service architecture in accordance with some embodiments of the present disclosure.

For further explanation, FIG. 6 illustrates an exemplary computing device 600 that may be specifically configured to perform one or more of the processes described herein. As shown in FIG. 6, computing device 600 may include a communication interface 602, a processor 604, a storage device 606, an input/output (I/O) module 608, and computer memory 614 communicatively connected one to another via a communication infrastructure 610. While an exemplary computing device 600 is shown in FIG. 6, the components illustrated in FIG. 6 are not intended to be limiting. Additional or alternative components may be used in other embodiments. Components of computing device 600 shown in FIG. 6 will now be described in additional detail.

Communication interface 602 may be configured to communicate with one or more computing devices. Examples of communication interface 602 include a wired network interface (such as a network interface card), a wireless network interface (such as a wireless network interface card), a modem, an audio/video connection, and any other suitable interface.

Processor 604 generally represents any type or form of processing unit capable of processing data and/or interpreting, executing, and/or directing execution of one or more of the instructions, processes, and/or operations described herein. Processor 604 may perform operations by executing computer-executable instructions 612 (e.g., an application, software, code, and/or other executable data instance) stored in storage device 606.

Storage device 606 may include one or more data storage media, devices, or configurations and may employ any type, form, and combination of data storage media and/or device. For example, storage device 606 may include any combination of non-volatile media and/or volatile media. Electronic data, including data described herein, may be temporarily and/or permanently stored in storage device 606. For example, data representative of computer-executable instructions 612 configured to direct processor 604 to perform any of the operations described herein may be stored within storage device 606. In some examples, data may be arranged in one or more databases residing within storage device 606.

I/O module 608 may include one or more I/O modules configured to receive user input and provide user output. I/O module 608 may include any hardware, firmware, software, or combination thereof supportive of input and output capabilities. For example, I/O module 608 may include hardware and/or software for capturing user input, including a keyboard or keypad, a touchscreen component (e.g., touchscreen display), a receiver (e.g., an RF or infrared receiver), motion sensors, and/or one or more input buttons.

I/O module 608 may include one or more devices for presenting output to a user, including a graphics engine, a display (e.g., a display screen), one or more output drivers (e.g., display drivers), one or more audio speakers, and one or more audio drivers. In certain embodiments, I/O module 608 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 600.

For further explanation and as an additional example of a supporting technology for securing an operating system, FIG. 7 sets forth a block diagram of a cloud service provider service architecture in accordance with some embodiments. The cloud service provider 702 can deliver a variety resources through a services-based consumption model where resources are consumed on-demand and as-a-service. Cloud service providers can provide services via cloud platforms such as, for example, Microsoft Azure™, Amazon Web Services (‘AWS’)™, Google Cloud Platform (‘GCP’)™, and others. In FIG. 7, the cloud service provider 702 is accessed from a client device 734 via a network 732.

FIG. 7 depicts an embodiment where software 720 is delivered as a service. Software-as-a-service (‘SaaS’) is a model where software applications are delivered over the internet as-a-service. Rather than installing and maintaining software locally, users can access software via a web browser or other network connected interface, eliminating the need for complex software and hardware management on the client-side. In FIG. 7, as examples of software 720 that can be delivered as-a-service, the illustrated embodiment includes office productivity 722 software, customer relationship management (‘CRM’) 724 software, and project management 726 software. The office productivity 722 software can include applications designed to facilitate common business and personal tasks, including word processing applications, applications for spreadsheet creation, presentation design applications, and many others. The CRM 724 software can include applications for managing a business organization's relationships and interactions with customers and potential customers. The project management 726 software can include applications designed to help teams plan, organize, and manage projects efficiently by facilitating collaboration and tracking the progress of projects. Readers will appreciate that in other embodiments, other types of software may be delivered using a SaaS model.

FIG. 7 depicts an embodiment where platforms 712 can be delivered as a service. Platform-as-a-service (‘PaaS’) is a model that provides cloud customers with platform resources that they can use to develop, run, and manage applications without the complexity of such deploying and managing such infrastructure on their own. In FIG. 7, as examples of platform 712 resources that can be delivered as-a-service, the illustrated embodiment includes database 714 services, development tools 716 services, and execution runtime 718 services. The database 714 services can be used to provide access to databases without management overhead for the user as the cloud service provider manages the provisioning, scaling, and maintenance of the databases. The development tools 716 services can provide developers with tools to design, develop, test, and deploy applications without needing to manage the underlying infrastructure. The execution runtime 718 services can provide environments where applications or other forms of computer program code can be executed, including services to scale the execution environment. Readers will appreciate that in other embodiments, other platform resources may be delivered using a PaaS model.

FIG. 7 depicts an embodiment where infrastructure 704 can be delivered as a service. Infrastructure-as-a-Service (‘IaaS’) is a model that provides virtualized computing resources over the internet, such that infrastructure such as servers, storage, networks, and others may be leased on demand rather than purchasing and maintaining physical hardware. In FIG. 7, as examples of infrastructure 704 resources that can be delivered as-a-service, the illustrated embodiment includes compute 706 services, storage 708 services, and networking 710 services. The compute 706 services can be used to provide on-demand access to computational resources such as VMs, containers, and serverless functions, where the cloud service provider manages the provisioning, scaling, and maintenance of such resources. The storage 708 services can provide storage resources that can be used to store and access data, without the need for customers to purchase and manage on-premises physical storage resources. The networking 710 services can provide the ability to create and manage virtualized networking resources such as, for example, virtual private networks (‘VPNs’), firewalls, load balancers, and more. Readers will appreciate that in other embodiments, other infrastructure resources may be delivered using a IaaS model.

The cloud service provider of FIG. 7 also provides management 730 resources. The management 730 resources can include, for example, tools and interfaces that enable customers to efficiently deploy, monitor, and manage, their cloud services. Such tools can include web-based management consoles, command-line interfaces (‘CLIs’), APIs, automation tools, and other tools.

The cloud service provider of FIG. 7 also provides security 728 resources. The security 728 resources can include, for example, tools and services to help customers protect their cloud environments and ensure compliance with security standards. These tools and services may provide specific aspects of security, including identity and access management, network security, threat detection, compliance management, and others.

Readers will appreciate that many of the components described above may be delivered as services from a cloud service provider. For example, the virtual machines, containers, and pods described above may all be delivered via a cloud service provider. In other embodiments, other forms of compute resources may be used in place of the virtual machines or other compute resource. For example, AWS EC2 instances or other form of cloud compute instances may be utilized in place of the virtual machines.

Advantages and features of the present disclosure can be further described by the following statements:
1. A method of performing low-latency write operations in a computing system, the method comprising: partitioning a set of processing units of the computing system into a first subset and a second subset; assigning, to each processing unit in the first subset, one or more dedicated threads configured to execute latency sensitive write path operations; assigning, to each processing unit in the second subset, one or more threads for performing latency insensitive operations; and processing write operations using the first subset of processing units, including: executing a non-blocking polling loop on the processing units in the first subset to detect input/output (‘I/O’) activity related to write path operations; and persisting write data to a storage device in the computing system.
2. The method of any combination of one or more of the statements above, wherein assigning a dedicated thread to each processing unit in the first subset further comprises binding the dedicated thread to the processing unit using thread affinity settings enforced by the computing system.
3. The method of any combination of one or more of the statements above, wherein executing the non-blocking polling loop further comprises evaluating, by each dedicated thread, a data structure storing write requests.
4. The method of any combination of one or more of the statements above, further comprising receiving, by each dedicated thread, data over a connection managed exclusively by the dedicated thread.
5. The method of any combination of one or more of the statements above, further comprising selecting, by the computing system, the first subset of processing units based on a performance isolation policy.
6. The method of any combination of one or more of the statements above, further comprising assigning, to each processing unit in the second subset, one or more threads configured to perform background operations that are not latency sensitive.
7. The method of any combination of one or more of the statements above, further comprising transmitting, by one or more processing units in the second subset, previously persisted write data to a remote storage system.
8. The method of any combination of one or more of the statements above, further comprising updating, by one or more processing units in the second subset, metadata associated with write data persisted by one or more processing units in the first subset.
9. An apparatus for performing low-latency write operations in a computing system, comprising: a memory; and one or more processing devices operatively coupled to the memory, the one or more processing devices configured to: partition a set of processing units of the computing system into a first subset and a second subset; assign, to each processing unit in the first subset, one or more dedicated threads configured to execute latency sensitive write path operations; assign, to each processing unit in the second subset, one or more threads for performing latency insensitive operations; and process write operations using the first subset of processing units, including: executing a non-blocking polling loop on the processing units in the first subset to detect input/output (‘I/O’) activity related to write path operations; and persisting write data to a storage device in the computing system.
10. The apparatus of any combination of one or more of the statements above, wherein, to assign a dedicated thread to each processing unit in the first subset, the one or more processing devices are further configured to bind the dedicated thread to the processing unit using thread affinity settings enforced by the computing system.
11. The apparatus of any combination of one or more of the statements above, wherein, to execute the non-blocking polling loop, the one or more processing devices are further configured to evaluate, by each dedicated thread, a data structure storing write requests.
12. The apparatus of any combination of one or more of the statements above, wherein the one or more processing devices are further configured to receive, by each dedicated thread, data over a connection managed exclusively by the dedicated thread.
13. The apparatus of any combination of one or more of the statements above, wherein the one or more processing devices are further configured to select the first subset of processing units based on a performance isolation policy.
14. The apparatus of any combination of one or more of the statements above, wherein the one or more processing devices are further configured to assign, to each processing unit in the second subset, one or more threads configured to perform background operations that are not latency sensitive.
15. The apparatus of any combination of one or more of the statements above, wherein the one or more processing devices are further configured to transmit, by one or more processing units in the second subset, previously persisted write data to a remote storage system.
16. The apparatus of any combination of one or more of the statements above, wherein the one or more processing devices are further configured to update, by one or more processing units in the second subset, metadata associated with write data persisted by one or more processing units in the first subset.
17. A non-transitory computer readable storage medium storing instructions which, when executed, cause a processing device to: partition a set of processing units of a computing system into a first subset and a second subset; assign, to each processing unit in the first subset, one or more dedicated threads configured to execute latency sensitive write path operations; assign, to each processing unit in the second subset, one or more threads for performing latency insensitive operations; and process write operations using the first subset of processing units, including: executing a non-blocking polling loop on the processing units in the first subset to detect input/output (‘I/O’) activity related to write path operations; and persisting write data to a storage device in the computing system.
18. The non-transitory computer readable storage medium of any combination of one or more of the statements above, wherein, to assign a dedicated thread to each processing unit in the first subset, the processing device is further configured to bind the dedicated thread to the processing unit using thread affinity settings enforced by the computing system.
19. The non-transitory computer readable storage medium of any combination of one or more of the statements above, wherein, to execute the non-blocking polling loop, the processing device is further configured to evaluate, by each dedicated thread, a data structure storing write requests.
20. The non-transitory computer readable storage medium of any combination of one or more of the statements above, wherein the processing device is further configured to receive, by each dedicated thread, data over a connection managed exclusively by the dedicated thread.

Although some embodiments are described largely in the context of a system, method, or in some other way, readers will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that some embodiments are described in which computer program instructions are executed on computer hardware such as, for example, one or more computer processors. Readers will appreciate that in other embodiments, computer program instructions may be executed on virtualized computer hardware (e.g., one or more virtual machines), in one or more containers, in one or more cloud computing instances (e.g., one or more AWS EC2 instances), in one or more serverless compute instances offered such as those offered by a cloud service provider, in one or more event-driven compute services such as those offered by a cloud service provider, or in some other execution environment.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include any combination of non-volatile storage media and/or volatile storage media. Exemplary non-volatile storage media include read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, FPGAs, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A method of performing low-latency write operations in a computing system, the method comprising:
partitioning a set of processing units of the computing system into a first subset and a second subset;
assigning, to each processing unit in the first subset, one or more dedicated threads configured to execute latency sensitive write path operations;
assigning, to each processing unit in the second subset, one or more threads for performing latency insensitive operations; and
processing write operations using the first subset of processing units, including:
executing a non-blocking polling loop on the processing units in the first subset to detect input/output (‘I/O’) activity related to write path operations; and
persisting write data to a storage device in the computing system.

2. The method of claim 1, wherein assigning a dedicated thread to each processing unit in the first subset further comprises binding the dedicated thread to the processing unit using thread affinity settings enforced by the computing system.

3. The method of claim 1, wherein executing the non-blocking polling loop further comprises evaluating, by each dedicated thread, a data structure storing write requests.

4. The method of claim 1, further comprising receiving, by each dedicated thread, data over a connection managed exclusively by the dedicated thread.

5. The method of claim 1, further comprising selecting, by the computing system, the first subset of processing units based on a performance isolation policy.

6. The method of claim 1, further comprising assigning, to each processing unit in the second subset, one or more threads configured to perform background operations that are not latency sensitive.

7. The method of claim 1, further comprising transmitting, by one or more processing units in the second subset, previously persisted write data to a remote storage system.

8. The method of claim 1, further comprising updating, by one or more processing units in the second subset, metadata associated with write data persisted by one or more processing units in the first subset.

9. An apparatus for performing low-latency write operations in a computing system, comprising:
a memory; and
one or more processing devices operatively coupled to the memory, the one or more processing devices configured to:
partition a set of processing units of the computing system into a first subset and a second subset;
assign, to each processing unit in the first subset, one or more dedicated threads configured to execute latency sensitive write path operations;
assign, to each processing unit in the second subset, one or more threads for performing latency insensitive operations; and
process write operations using the first subset of processing units, including:
executing a non-blocking polling loop on the processing units in the first subset to detect input/output (‘I/O’) activity related to write path operations; and
persisting write data to a storage device in the computing system.

10. The apparatus of claim 9, wherein, to assign a dedicated thread to each processing unit in the first subset, the one or more processing devices are further configured to bind the dedicated thread to the processing unit using thread affinity settings enforced by the computing system.

11. The apparatus of claim 9, wherein, to execute the non-blocking polling loop, the one or more processing devices are further configured to evaluate, by each dedicated thread, a data structure storing write requests.

12. The apparatus of claim 9, wherein the one or more processing devices are further configured to receive, by each dedicated thread, data over a connection managed exclusively by the dedicated thread.

13. The apparatus of claim 9, wherein the one or more processing devices are further configured to select the first subset of processing units based on a performance isolation policy.

14. The apparatus of claim 9, wherein the one or more processing devices are further configured to assign, to each processing unit in the second subset, one or more threads configured to perform background operations that are not latency sensitive.

15. The apparatus of claim 9, wherein the one or more processing devices are further configured to transmit, by one or more processing units in the second subset, previously persisted write data to a remote storage system.

16. The apparatus of claim 9, wherein the one or more processing devices are further configured to update, by one or more processing units in the second subset, metadata associated with write data persisted by one or more processing units in the first subset.

17. A non-transitory computer readable storage medium storing instructions which, when executed, cause a processing device to:
partition a set of processing units of a computing system into a first subset and a second subset;
assign, to each processing unit in the first subset, one or more dedicated threads configured to execute latency sensitive write path operations;
assign, to each processing unit in the second subset, one or more threads for performing latency insensitive operations; and
process write operations using the first subset of processing units, including:
executing a non-blocking polling loop on the processing units in the first subset to detect input/output (‘I/O’) activity related to write path operations; and
persisting write data to a storage device in the computing system.

18. The non-transitory computer readable storage medium of claim 17, wherein, to assign a dedicated thread to each processing unit in the first subset, the processing device is further configured to bind the dedicated thread to the processing unit using thread affinity settings enforced by the computing system.

19. The non-transitory computer readable storage medium of claim 17, wherein, to execute the non-blocking polling loop, the processing device is further configured to evaluate, by each dedicated thread, a data structure storing write requests.

20. The non-transitory computer readable storage medium of claim 17, wherein the processing device is further configured to receive, by each dedicated thread, data over a connection managed exclusively by the dedicated thread.
